(19) United States
(12) Patent Application Publication
(10) Pub. No.: US 2012/0212440 A1
(43) Pub. Date: Aug. 23, 2012

(54) INPUT MOTION ANALYSIS METHOD AND INFORMATION PROCESSING DEVICE

(75) Inventors: Osamu Nishida, Osaka (JP); Teruo Hohjoh, Osaka (JP); Shingo Nomura, Osaka (JP)

(73) Assignee: SHARP KABUSHIKI KAISHA, Osaka (JP)

(21) Appl. No.: 13/502,585

(22) PCT Filed: Jun. 1, 2010
(86) PCT No.: PCT/JP2010/059269

§ 371 Date: Apr. 18, 2012

(30) Foreign Application Priority Data
Oct. 19, 2009 (JP) 2009-240661

(51) Int. Cl. G06F 3/041

(52) U.S. Cl. 345/173

(57) ABSTRACT

Provided are an input motion analysis method and an information processing device that enable simultaneous multi-point input via different input instruments to be correctly performed as intended by an operator. The information processing device according to the present invention can simultaneously receive an input motion of a finger (2) and an input motion of a pen (3) that is thinner than the finger (2) in the same input region (1) in a display screen. When an operator performs a first input motion by moving his/her finger (2) or a pen (3) along a surface of the input region (1) while keeping at least the finger (2) in contact with or close to the input region (1), the information processing device analyzes the first input motion by the finger (2) or the pen (3) based on, instead of an input tool assessment criterion provided for assessing an input motion by the pen (3), a finger assessment criterion provided for assessing an input motion by the finger (2) and that has a lower resolution to assess input motions than that of the input tool assessment criterion.

### TECHNICAL FIELD

The present invention relates to an information processing device that allows for an handwritten input on an information display screen by at least one of an input tool such as a pen and a finger, and more particularly, to an input motion analysis method for analyzing an input motion of a pen or a finger received by the information processing device and for processing information in accordance with the input motion, and an information processing device that performs the input motion analysis method.

### BACKGROUND ART

Conventionally, a touch panel (touch sensor) has been developed as an input device that can detect a position where an input tool such as a pen, a finger, or the like touches an information display screen, and that can communicate an operator's intention to an information processing device or an information processing system that is equipped with the information display screen. As a display device incorporating such a touch panel into an information display screen integrally, a liquid crystal display device with an integrated touch panel is widely used, for example.

As methods for detecting input positions on a touch panel, an electrostatic capacitance coupling method, a resistive film method, an infrared method, an ultrasonic method, an electromagnetic induction/coupling method, and the like are known.

Patent Document 1 below discloses an input device that has separate regions for a pen-based input and for a finger-based input.

FIG. 11 is an explanatory diagram showing an example of displaying various icons. These icons allow operators to perform various input operations on an operation panel 20 that is made of a display panel and a transparent touch panel disposed thereon.

A “keyboard” icon 61 that resembles a musical keyboard, for example, represents a keyboard that corresponds to a range of a selected part (musical instrument), and by touching the keyboard, an operator can play the selected note with the timbre of the selected part.

Icons 62 and 63 are used to change the tone range of the keyboard indicated with the “keyboard” icon 61 by one octave at a time.

Various icons 64 to 66 have functions of calling up screens for changing settings of musical parameters that control timbres and sound formations. An icon 67 has a function of increasing or decreasing values of the musical parameters.

In order to allow an operator to play comfortably using the operation panel 20, in the “keyboard” icon 61 and the icons 62 and 63, it is preferable that the time required for determining an input and responding thereto be short. In contrast, with regard to the icons used to change various current settings such as the icons 64 to 67, it is more convenient if the time required for determining an input and responding thereto is rather long so that input errors can be prevented.

When the touch panel turns to a pressed state from a non-pressed state, a voltage indicative of a correct pressed position is not output immediately, and therefore, generally, it is necessary to allow a slight time lag. This time lag becomes greater as the touch panel is pressed by an object having a larger pressing area (a finger, for example), and the longer time is required for determining the pressed position.

For this reason, Patent Document 1 discusses that it is desirable to separately provide a first input region that is operated mainly by a pen or the like that has a smaller pressing area, and a second input region that is operated mainly by a finger or the like that has a larger pressing area, and to arrange the “keyboard” icon 61 and the icons 62 and 63 in the first input region, and the icons 64 to 67 in the second input region. It also discusses that the respective input regions desirably use different methods to determine a position where the pressing operation is performed.

### RELATED ART DOCUMENTS

### Patent Documents

Patent Document 1: Japanese Patent Application Laid-Open Publication No. 2005-99871 (Publication date: Apr. 14, 2005)

Patent Document 2: Japanese Patent Application Laid-Open Publication No. 2007-58552 (Publication date Mar. 8, 2007)

### SUMMARY OF THE INVENTION

### Problems to be Solved by the Invention

However, the operation panel 20 of Patent Document 1 above has a problem in that because it is configured such that the first input region that is operated by a pen or the like and the second input region that is operated by a finger or the like are separately provided, and the regions are not interchangeable, an operator cannot freely choose the easier one between a pen and a finger to perform an input operation in the input region.

Also, the above-mentioned operation panel 20 cannot be used for a multi-point input scheme that allows a pen and a finger to be in contact with a single input region simultaneously and that performs the more sophisticated input processing by detecting a positional change of at least one of the pen and the finger.

Patent Document 2 above discloses an example of such a multi-point input scheme, for example. As a specific example of the input processing, Patent Document 2 introduces the following display processing: when a display image of a certain shape and size is displayed, the left and right edges of the displayed image are touched by two fingers of an operator, and in accordance with a change in the touched positions, the display size of the displayed image is changed.

However, in performing the simultaneous multi-point input via different input instruments such as a pen and a finger, it is necessary to make a position determining method for a pen and a position determining method for a finger differ from each other as described in Patent Document 1, but this point is not taken into account at all in Patent Document 2. Therefore, as described in embodiments of the present invention below, when the simultaneous multi-point input via different input instrument is performed, a response intended by an operator may not be provided, resulting in an erroneous operation from a viewpoint of the operator.

The present invention was made in view of the above-mentioned problems, and it is a main object of the present invention to provide an input motion analysis method and an information processing device that enable a simultaneous multi-point input via different input instruments to be correctly performed as intended by an operator.

### Means for Solving the Problems

In order to solve the above-mentioned problems, an information processing device according to the present invention is (1) capable of simultaneously receiving an input motion of a finger and an input motion of an input tool thinner than the finger in a single input region in a display screen, and performing information processing in accordance with the input motions, and the information processing device includes:

(2) an input identifying unit that determines whether the input tool or the finger is in contact with or close to the input region;

(3) a storage unit that therein stores an input tool assessment criterion and a finger assessment criterion, the input tool assessment criterion being provided for assessing the input motion by the input tool, the finger assessment criterion being provided for assessing the input motion by a finger and having a lower resolution to assess input motions than that of the input tool assessment criterion; and

(4) an analysis unit that calls up the finger assessment criterion from the storage unit and that analyzes a first input motion by the input tool or a finger based on the finger assessment criterion when the input identifying unit determines that a finger is in contact with or close to the input region in at least one location and when the first input motion of moving the input tool or a finger along a surface of the input region is performed.

In the above-mentioned configuration, an input motion of the input tool and an input motion of a finger include all of the following: a motion of the input tool or a finger to touch or get close to the input region; the first input motion, which is moving the input tool or a finger along a surface of the input region; and a motion of the input tool or a finger moving away from the input region. That is, the first input motion is one mode of the input motions.

According to the above-mentioned configuration, the different assessment criteria are used for the input motion by the input tool thinner than a finger, and for the input motion by a finger. This is because, considering respective input areas of the input tool and a finger that are respectively in contact with or close to the input region, the input area of the finger is larger than the input area of the input tool, and therefore, the finger causes a greater change in output coordinates than the input tool.

Generally, the first input motions by the input tool that is thinner than a finger include writing small a letter, writing a text, or the like, for example, which are smaller motions than those by a finger. Therefore, the input tool assessment criterion can provide a higher resolution in assessing all input motions so that the first input motion smaller than the finger assessment criterion can be recognized.

This means that if the input tool assessment criterion is used to assess the first input motion by a finger, for example, an unintended motion of the finger of the operator may be recognized as the first input motion, possibly causing an erroneous operation that was not intended by the operator.

To address this issue, when the input identifying unit determines that a finger is in contact with or close to the input region in at least one location, even if the input tool is determined to be in contact with or close to the input region in another location at the same time, the analysis unit analyzes the first input motions using the finger assessment criterion, instead of the input tool assessment criterion, with respect to both of the first input motion by the input tool and the first input motion by the finger.

This prevents an unintended motion of the finger of the operator from being erroneously recognized as the first input motion, and therefore, it enables a simultaneous multi-point input via different input instruments to be correctly performed as intended by an operator.

The input region may be a part of the display screen, or it may be the entire display screen.

In order to solve the above-mentioned problems, an input motion analysis method according to the present invention is performed by an information processing device, the information processing device being capable of simultaneously receiving an input motion of a finger and an input motion of an input tool thinner than the finger in a single input region in a display screen, the information processing device performing information processing in accordance with the input motions, the input motion analysis method including:

when an operator of the information processing device performs a first input motion by moving the input tool or the finger along a surface of the input region while keeping at least the finger in contact with or close to the input region, analyzing the first input motion of the input tool or the finger based on a finger assessment criterion, instead of an input tool assessment criterion, the input tool assessment criterion being provided for assessing the input motion of the input tool, the finger assessment criterion being provided for assessing the input motion by a finger and having a lower resolution to assess input motions than that of the input tool assessment criterion.

As described above, this prevents an unintended motion of the finger of the operator from being erroneously recognized as the first input motion, and therefore, it enables the simultaneous multi-point input via different input instruments to be correctly performed as intended by an operator.

### Effects of the Invention

As described above, the information processing device and the input motion analysis method according to the present invention are configured such that when the operator performs the first input motion by moving the input tool or a finger along the surface of the input region of the display screen while keeping at least a finger in contact with or close to the same input region, the information processing device performs an analysis on the first input motion by the input tool or the finger based on the finger assessment criterion provided for assessing an input motion by a finger, instead of using the input tool assessment criterion provided for assessing an input motion by the input tool.

This prevents an unintended motion of the finger of the operator from being erroneously recognized as the first input motion, resulting in an effect of enabling the simultaneous multi-point input via different input instruments to be correctly performed as intended by the operator.

### BRIEF DESCRIPTION OF THE DRAWINGS

FIG. 1 is an explanatory diagram for explaining input motions of the present invention that uses an input pen and a finger simultaneously.

FIG. 2 is a block diagram schematically showing an overall configuration of an information processing device according to the present invention.

FIG. 3 is a block diagram showing a more specific configuration for performing a gesture input and a handwriting input.

FIG. 4 is a block diagram showing a part of a configuration of a touch panel control board that handles a process of distinguishing an input motion by a finger from an input motion by a pen.

FIG. 5 is a cross-sectional view that schematically shows a cross-section of a liquid crystal display panel with a built-in optical sensor.

FIG. 6 is a schematic view that shows a process of detecting a position of an input made to a touch panel by sensing an image of an object.

FIG. 7 is a diagram showing an image data that is output by a liquid crystal display panel with a built-in optical sensor.

FIG. 8 is an explanatory diagram showing a difference in a threshold T2 for a contact time between a finger and a pen.

FIG. 9 is a flowchart showing steps of an input motion judgment process for a second input motion.

FIG.10 is a flowchart showing steps of an input motion judgment process for a first input motion.

FIG. 11 is an explanatory diagram showing an example of a conventional configuration in which various icons are displayed on an operation panel that is made of a display panel and a transparent touch panel disposed thereon so that an operator can perform various input operations.

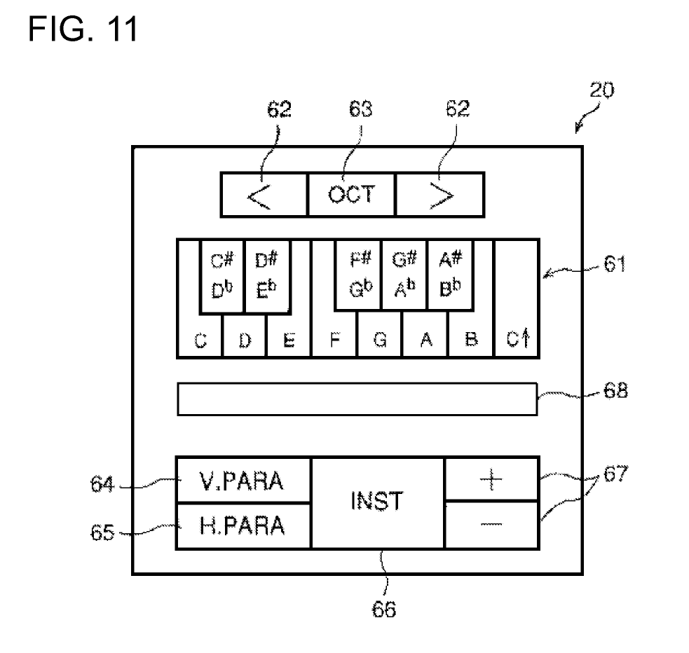

### DETAILED DESCRIPTION OF EMBODIMENTS

Embodiments of the present invention will be explained in detail below.

### Embodiment 1

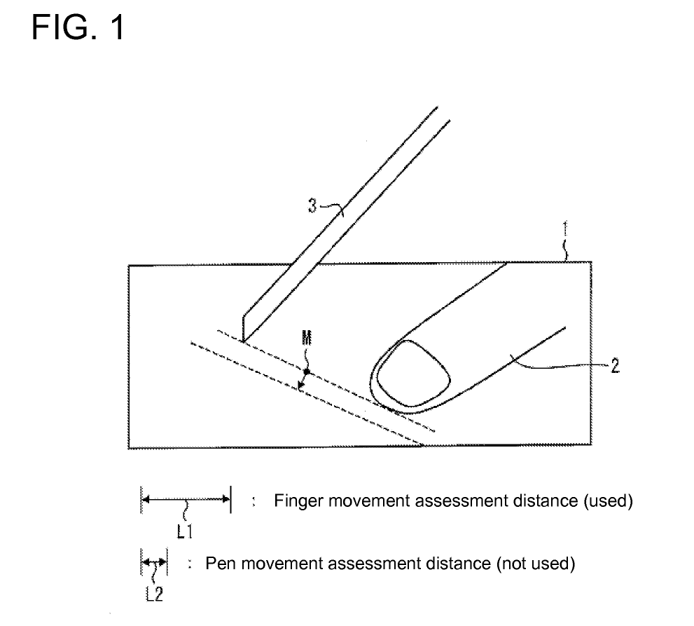

An embodiment of the present invention will be explained as follows with reference to FIGS. 1 to 10.

Input Motion Analysis Method

First, an input motion analysis method of the present invention will be explained in detail. FIG. 1 is an explanatory diagram for explaining input motions that use an input pen and a finger simultaneously. As shown in FIG. 1, an information processing device according to the present invention is capable of simultaneously receiving input motions provided with respect to a single input region 1 in a display screen by a finger 2 and by a pen 3, which is an input tool thinner than the finger 2, and processing information in accordance with the input motions.

An input motion in which an operator of the information processing device moves the finger 2 or the pen 3 along a surface of the input region 1 while keeping at least the finger 2 in contact with or close to the input region 1 is referred to as a first input motion.

When analyzing this first input motion, the information processing device employs a finger assessment criterion provided for assessing an input motion by the finger 2, instead of an input tool assessment criterion provided for assessing an input motion by the pen 3.

More specifically, as the input tool assessment criterion, a threshold for a distance travelled by the pen 3 along the surface of the input region 1 can be used. As the finger assessment criterion, a threshold for a distance travelled by the finger 2 along the surface of the input region 1 can be used. The above-mentioned thresholds may also be referred to as prescribed parameters for analyzing the first input motions.

In the present invention and in the present embodiment, the input tool assessment criterion and the finger assessment criterion are configured so as to differ from each other. More specifically, the finger assessment criterion has a lower resolution to assess input motions as compared with the input tool assessment criterion. As shown in FIG. 1, for example, a threshold L1 for the travel distance of the finger 2 is configured to be larger than a threshold L2 for the travel distance of the pen 3.

Contact areas where the finger 2 and the pen 3 respectively make contact with the input region 1, and areas of shadows projected on the surface of the input region 1 by the finger 2 and by the pen 3 being close to the input region 1 are collectively referred to as input areas. It should be noted that the area of the shadow is an area of a complete shadow that is detectable as an input, and an area of a penumbra at the periphery or the like of the complete shadow is generally excluded by the sensitivity threshold in detecting an input.

As described above, the threshold L2 of the pen 3 is configured to be smaller than the threshold L1 of the finger 2. This is because the input area of the finger 2 is larger than the input area of the pen 3, and therefore, the finger 2 causes a greater change in output coordinates as compared with the pen 3.

Generally, the first input motions by the pen 3 that is thinner than the finger 2 include writing a small letter, writing a text, or the like, for example, which are smaller motions than those by the finger 2. Therefore, the input tool assessment criterion has a higher resolution to assess all input motions so that first input motions that are smaller than the finger assessment criterion can be recognized.

Thus, if the input tool assessment criterion is used to assess the first input motion by the finger 2, for example, an unintended motion of the finger 2 of the operator may be recognized as the first input motion, possibly causing an erroneous operation that was not intended by the operator.

An example of such a situation is as follows: an operator performs the first input motion (gestures, writing a character, or the like) using the pen 3 at a certain position in the input region 1 while keeping the finger 2 in contact with the input region 1 at another position. In this case, although the operator thinks that the finger 2 is not moving from the same position, the actual input area becomes smaller or larger, thereby continuously changing the coordinates of a representative point (will be described later) that indicates the position of the finger 2. Thus, if the multi-point input where the operator moves the pen 3 while holding the finger 2 at one position is assessed based on the input tool assessment criterion, not only the motion of the pen 3 is recognized, but also an unintended motion of the finger 2 is erroneously recognized as the first input motion.

To address this issue, when the finger 2 of the operator is determined to be in contact with or close to the input region 1 in at least one location, even if the pen 3 is determined to be in contact with or close to the input region 1 in another location at the same time, an analysis on the first input motion is conducted based on the finger assessment criterion, instead of the input tool assessment criterion with respect to both of the first input motion by the finger 2 and the first input motion by the pen 3. The above-mentioned first input motion performed in the other location by the pen 3 may also be conducted by a finger other than the finger 2.

This prevents an unintended motion of the finger 2 of the operator from being erroneously recognized as the first input motion, and therefore, it enables the simultaneous multi-point input via different input instruments to be correctly performed as intended by the operator.

FIG. 1 shows an example of comparing the threshold L1 of the finger 2 with a travel distance of a midpoint M between a point where the presence of the finger 2 on or near the input region 1 is detected and a point where the present of the pen 3 on or near the input region 1 is detected.

By comparing the travel distance of the midpoint M with the threshold L1 of the finger 2, even if the finger 2 moves to a certain extent, if the movement is smaller than the threshold L1, the midpoint M is deemed to have not moved. In contrast, if the travel distance of the midpoint M is compared with the threshold L2 of the pen 3, because the threshold L2 is significantly smaller than the threshold L1, even with a slight movement of the finger 2, the midpoint M may be deemed to have moved, possibly resulting in an erroneous operation that was not intended by the operator.

According to the input motion analysis method of the present invention, when the first input motion that simultaneously uses the finger 2 and the pen 3 is performed, if the input motion by the finger 2 is detected, the threshold L1 of the finger 2 is always used as the assessment criterion of the input motion. This makes it possible to prevent the above-mentioned erroneous operation.

An information processing device for conducting the above-mentioned input motion analysis method will be explained below.

Overall Configuration of Information Processing Device

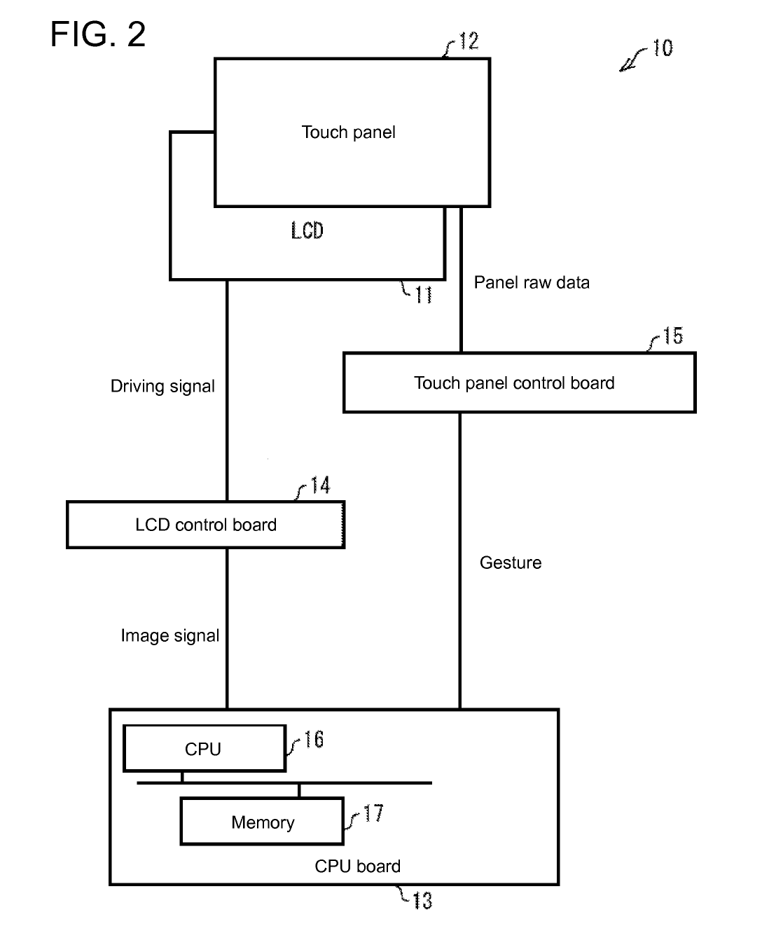

FIG. 2 is a block diagram schematically showing an overall configuration of an information processing device 10 of the present invention.

The information processing device 10 is a PDA (Personal Digital Assistants) or a PC (Personal Computer) equipped with a touch panel. A touch panel 12 is integrally disposed on a liquid crystal display (LCD) 11.

As the liquid crystal display (hereinafter abbreviated as LCD) 11 and the touch panel 12, a liquid crystal display device in which optical sensor elements are provided for respective pixels can be used. Such a liquid crystal display device with built-in optical sensors can achieve a thinner profile than a configuration where the LCD 11 and the touch panel 12 are provided as individual elements.

The liquid crystal display device with built-in optical sensors is capable of not only displaying information, but also detecting an image of an object that is in contact with or close to a display screen. This means that the liquid crystal display device is capable of not only detecting an input position of the finger 2 or the pen 3, but also reading an image of a printed material and the like (scanning) by detecting an image. The device used for a display is not limited to a liquid crystal display, and it may also be an organic EL (Electro Luminescence) panel and the like.

The information processing device 10 further includes a CPU board 13, an LCD control board 14, and a touch panel control board 15 as a configuration to control operations of the LCD 11 and the touch panel 12.

The LCD control board 14 is connected between the LCD 11 and the CPU board 13, and converts an image signal that is output from the CPU board 13 to a driving signal. The LCD 11 is driven by the driving signal, and displays information corresponding to the image signal.

The touch panel control board 15 is connected between the touch panel 12 and the CPU board 13, and converts data that is output from the touch panel 12 to gesture data. The term “gesture” used here means a trajectory of the finger 2 or the pen 3 that moves along the display screen in the input region 1 that is a part of or the entire display screen of the information processing device 10. Various trajectories that form various shapes respectively correspond to commands that give instructions on specific information processing.

Types of the gestures can broadly be categorized into MOVE (moving), PINCH (expanding or shrinking), and ROTATE (rotating).

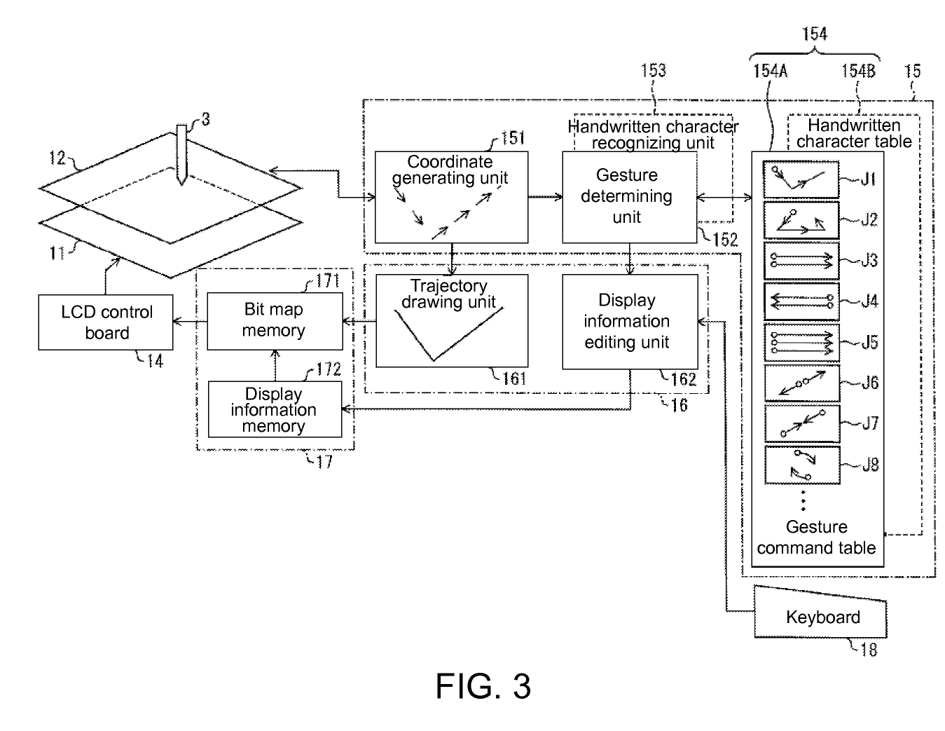

As exemplified in a gesture command table in FIG. 3 that will be described later, MOVE includes not only single-touch gestures J1, J2, and the like, but also multi-touch gestures J3, J4, J5, and the like.

PINCH, which is shown as gestures J6 and J7, is an input motion that expands or shrinks a distance between two input points on the input region 1, for example.

ROTATE, which is shown as a gesture J8, is an input motion that moves two input points in the clockwise or counter-clockwise direction with respect to one another, for example.

The gestures may also include a touch-down motion (DOWN) that moves the finger 2 or the pen 3 so as to make contact with or get closer to the input region 1, or a touch-up motion (UP) that moves the finger 2 or the pen 3 that has been in contact with or close to the input region 1 away from the input region 1.

The gesture data is sent to the CPU board 13, and a CPU 16 provided in the CPU board 13 recognizes a command corresponding to the gesture data, thereby conducting an information processing in accordance with the command.

In the CPU board 13, a memory 17, which is made of an ROM (Read Only Memory) that stores various programs for controlling operations of the CPU 16, or made of an RAM (Random Access Memory) that temporality stores data that is being processed, or the like, is provided.

The data output from the touch panel 12 is voltage data in case of employing the resistive film scheme as a touch panel scheme, electrostatic capacitance data in case of employing the electrostatic capacitance coupling scheme, or an optical sensor data in case of employing the optical sensor scheme, for example.

Specific Configuration for Conducting Gesture Input and the Like

Next, a more specific configuration of the touch panel control board 15, the CPU 16, and the memory 17 for conducting the gesture input and the handwriting input will be explained with reference to FIG. 3.

The touch panel control board 15 includes a coordinate generating unit 151, a gesture determining unit 152, a handwritten character recognizing unit 153, and a memory 154. The memory 154 is provided with a storage unit 154A that stores the gesture command table and a storage unit 154B that stores a handwritten character table.

The CPU 16 is provided with a trajectory drawing unit 161 and a display information editing unit 162, which perform different functions.

The memory 17 is provided with a bit map memory 171 and a display information memory 172, which store different types of data.

The coordinate generating unit 151 generates coordinate data of a position where the finger 2 or the pen 3 is in contact with or close to the input region 1 of the LCD 11 and the touch panel 12, and further sequentially generates trajectory coordinate data indicative of a change in the position.

The gesture determining unit 152 matches the trajectory coordinate data generated by the coordinate generating unit 151 to data of the basic strokes of commands stored in the gesture command table, and identifies a command corresponding to a basic stroke that is a closest match to an outline drawn by the trajectory coordinates.

Next, if the gesture that has been provided to the input region 1 is a gesture that requests an editing of a text or a shape displayed in the LCD 11, for example, after identifying the above-mentioned command, the gesture determining unit 152 provides the display information editing unit 162 with the identified command as well as positional information of the to-be-edited character, text, or shape, which has been obtained based on the trajectory coordinates.

The trajectory drawing unit 161 generates a trajectory image by connecting the respective trajectory coordinates based on the trajectory coordinate data generated by the coordinate generating unit 151. The trajectory image is supplied to the bit map memory 171 where it is synthesized with an image displayed on the LCD 11, and is thereafter sent to the LCD 11.

The display information editing unit 162 performs an editing process in accordance with the command with respect to a character, a text, or a shape that corresponds to the positional information supplied by the gesture determining unit 152 among characters, texts, or shapes that have been stored in the display information memory 172 as data.

The display information editing unit 162 is also capable of accepting a command input through a keyboard 18, in addition to the gesture command from the gesture determining unit 152, and performing an editing process by a key-based operation.

The display information memory 172 is a memory that stores information displayed on the LCD 11, and is provided in the RAM, together with the bit map memory 171. Various kinds of information stored in the display information memory 172 are synthesized with an image in the bit map memory 171, and is displayed on the LCD 11 through the LCD control board 14.

The handwritten character recognizing unit 153 matches the trajectory coordinates extracted by the coordinate generating unit 151 to a plurality of basic character strokes stored in the handwritten character table, identifies a character code that corresponds to a basic character stroke that is a closest match to the outline drawn by the trajectory coordinates, and outputs the character code to the display information editing unit 162.

Specific Configuration for Determining Input Instrument

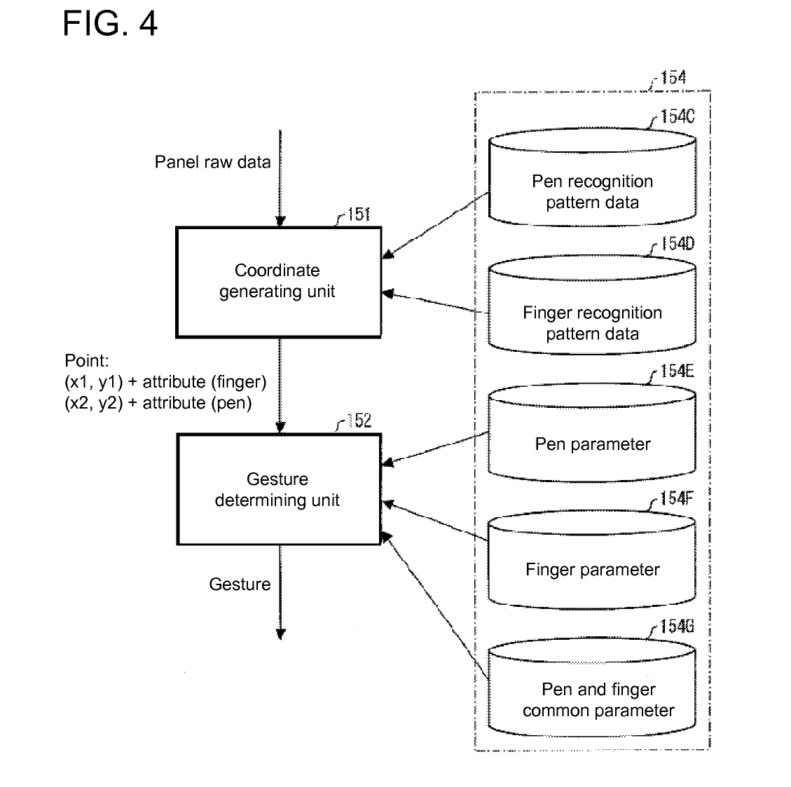

Next, a specific configuration for distinguishing the input motion by the finger 2 from the input motion by the pen 3 performed in the input region 1 will be explained with reference to FIG. 4.

FIG. 4 is a block diagram showing a part of a configuration of the touch panel control board 15 that handles a process for distinguishing the input motion by the finger 2 from the input motion by the pen 3. As shown in FIG. 4, the memory 154 of the touch panel control board 15 includes a storage unit 154C that stores pen recognition pattern data, a storage unit 154D that stores finger recognition pattern data, a storage unit 154E that stores a pen parameter, a storage unit 154F that stores a finger parameter, and a storage unit 154G that stores a pen and finger common parameter, in addition to the storage units that respectively store the gesture command table 154A and the handwritten character table 154B.

As described above, when the finger 2 or the pen 3 makes contact with or gets closer to the input region 1, a region with a certain size of an input area is specified by the finger 2 or the pen 3. A representative point of this region is detected by the coordinate generating unit 151 and this allows the coordinate generating unit 151 to generate coordinate data (x, y) indicative of an input position of the finger 2 or the pen 3.

In order to help the coordinate generating unit 151 to determine whether it is the finger 2 or the pen 3 that is in contact with or close to the input region 1, the finger recognition pattern data is prepared for the finger 2, and the pen recognition pattern data is prepared for the pen 3. That is, when the finger 2 or the pen 3 is in contact with or close to the input region 1, the coordinate generating unit 151 matches data that is output from the touch panel 12 (panel raw data) to the finger recognition pattern data and the pen recognition pattern data. This way, the coordinate generating unit 151 can generate attribute data indicative of an input instrument, which is the finger 2 or the pen 3, that is in contact with or close to the input region 1, as well as coordinate data (x1, y1) for the input position of the finger 2, or coordinate date (x2, y2) for the input position of the pen 3.

This means that this coordinate generating unit 151 corresponds to the input identifying unit of the present invention that determines which of the input tool and the finger is in contact with or close to the input region.

On the other hand, the finger parameter is the finger assessment criterion that has been already described, and is used to detect a relatively large positional change caused by the finger 2. This parameter is prepared as the above-mentioned threshold L1 for the travel distance of the finger 2, for example.

The pen parameter is the input tool assessment criterion that has been already described, and is used to detect a relatively small positional change caused by the pen 3. This parameter is prepared as the above-mentioned threshold L2 for the travel distance of the pen 3, for example.

The pen and finger common parameter is a parameter that does not require the attribute differentiation between the finger 2 and the pen 3. An example of such a parameter is a parameter indicative of the maximum number of touch points that can be recognized in a multi-point input by a plurality of fingers or a multi-point input by at least one finger, which is the finger 2, and the pen 3.

The gesture determining unit 152 identifies gestures based on the finger parameter for the input motion of the finger 2 and the pen parameter for the input motion of the pen 3, and by employing the pen and finger common parameter in addition thereto.

Detection of Representative Point by Liquid Crystal Display Panel with Built-In Optical Sensor

(1) Schematic Configuration of Liquid Crystal Display Panel with Built-In Optical Sensor

Described below is an example of a configuration that allows the coordinate generating unit 151 to generate the attribute data for differentiating the finger 2 from the pen 3 and to generate the coordinate data (x, y) of the input position by identifying the representative point.

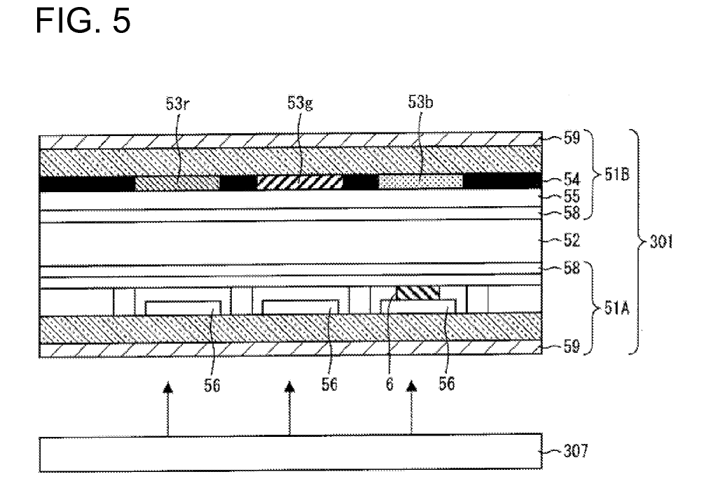

FIG. 5 is a cross-sectional view schematically showing a cross-section of a liquid crystal display panel with built-in optical sensors 301. The liquid crystal display panel with built-in optical sensors 301 described here is one example, and a display panel of any configurations may be used as long as the display panel has a display surface that doubles as a scanning surface.

As shown in the figure, the liquid crystal display panel with built-in optical sensors 301 is configured so as to have an active matrix substrate 51A disposed on the rear surface side, an opposite substrate 51B disposed on the front surface side, and a liquid crystal layer 52 sandwiched between these substrates. The active matrix substrate 51A includes pixel electrodes 56, a photodiode 6 and an optical sensor circuit thereof (not shown), an alignment film 58, a polarizer 59, and the like. The opposite substrate 51B includes color filters 53r (red), 53g (green), and 53b (blue), a light-shielding film 54, an opposite electrode 55, an alignment film 58, a polarizer 59, and the like. On the rear surface of the liquid crystal display panel with built-in optical sensors 301, a backlight 307 is provided.

(2) Input Position Detection Method

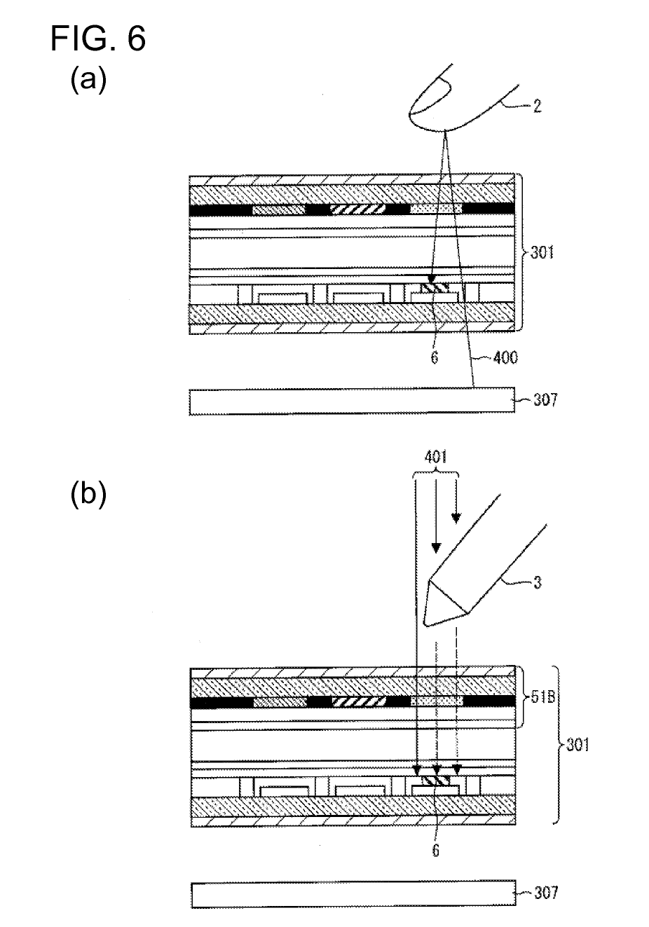

Next, with reference to FIGS. 6(a) and 6(b), two different methods for detecting an input position where an operator places the finger 2 or the pen 3 on or near the liquid crystal display panel with built-in optical sensors 301 will be explained.

FIG. 6(a) is a schematic view showing the input position being detected by sensing a reflected image. When light 400 is emitted from the backlight 307, the optical sensor circuit including the photodiode 6 senses the light 400 reflected by an object such as the finger 2, which makes it possible to detect the reflected image of the object. This way, by sensing the reflected image, the liquid crystal display panel with built-in optical sensors 301 can detect the input position.

FIG. 6(b) is a schematic view showing the input position being detected by sensing a shadow image. As shown in FIG. 6(b), the optical sensor circuit including the photodiode 6 senses ambient light 401 that has passed through the opposite substrate 51B and the like. However, when there is an object such as the pen 3, the incident ambient light 401 is blocked by the object, thereby reducing an amount of light sensed by the optical sensor circuit. This makes it possible to detect a shadow image of the object. This way, by sensing the shadow image, the liquid crystal display panel with built-in optical sensors 301 can also detect the input position.

As described above, the photodiode 6 may detect the reflected image generated by reflected light of the light emitted from the backlight 307, or it may detect the shadow image generated by the ambient light. The two types of the detection methods may also be used together so that both the shadow image and the reflected image are detected at the same time.

(3) Entire Image Data/Partial Image Data/Coordinate Data

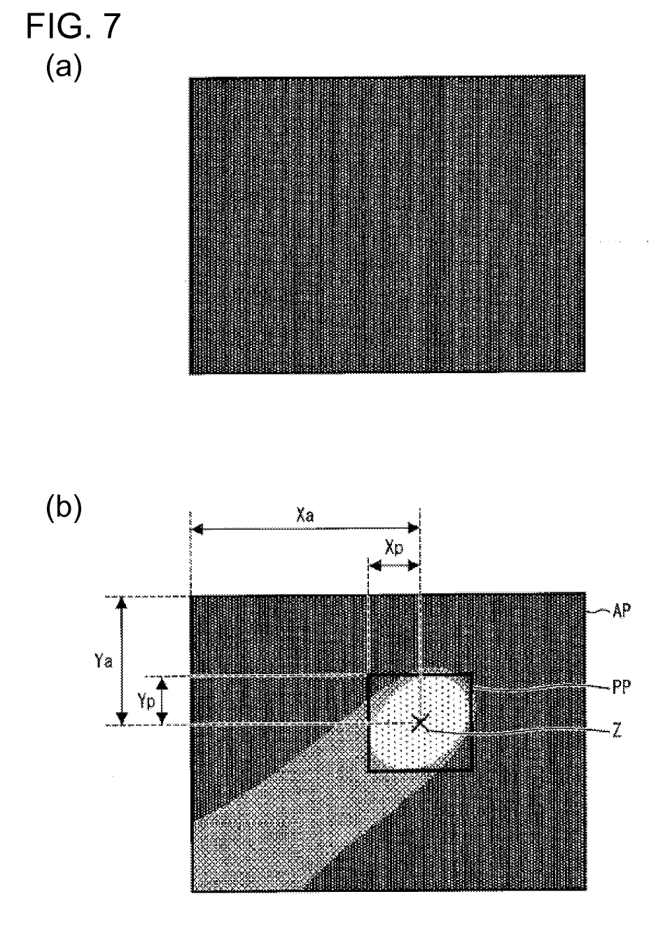

Next, referring to FIG. 7, entire image data, partial image data, and coordinate data will be explained with examples.

Image data shown in FIG. 7(a) is image data that can be obtained as a result of scanning the entire liquid crystal display panel with built-in optical sensors 301 or the entire input region 1 when no object is placed on the liquid crystal display panel with built-in optical sensors 301.

Image data shown in FIG. 7(b) is image data that can be obtained as a result of scanning the entire liquid crystal display panel with built-in optical sensors 301 or the entire input region 1 when an operator placed a finger on or near the liquid crystal display panel with built-in optical sensors 301.

When the operator placed the finger on or near the liquid crystal display panel with built-in optical sensors 301 or the input region 1, an amount of light received by the optical sensor circuits located near the input position is changed. This causes a change in voltages that are output by these optical sensor circuits, and as a result, in the generated image data, the brightness of the pixel values is changed near the input position.

In the image data shown in FIG. 7(b), the brightness of the pixel values is increased in a portion that corresponds to the finger of the operator as compared with the image data shown in FIG. 7(a). This allows the coordinate generating unit 151 to identify the smallest rectangular region (region PP) that includes all of the pixel values in which the brightness is greatly changed as compared with a prescribed threshold in the image data shown in FIG. 7(b). Image data included in this region PP is referred to as the “partial image data.”

The image data shown in FIG. 7(a) is image data that corresponds to an entire region AP, i.e., the “entire image data.”

The center point or the median point of the partial image data (region PP) can be specified as the above-mentioned representative point, i.e., the input position. Coordinate data Z of the representative point can be represented by coordinate data (Xa, Ya) where the top left corner of the entire region AP, for example, is used as the origin of the Cartesian coordinate system. Coordinate data (Xp, Yp) where the top left corner of the region PP is used as the origin may also be obtained as well.

The finger recognition pattern data and the pen recognition pattern data shown in FIG. 4 are compared with the region PP so as to determine whether the input has been made by the finger 2 or the pen 3. The finger recognition pattern data and the pen recognition pattern data may be prepared as a rectangular shape pattern similar to the region PP, for example, so as to identify the finger 2 or the pen 3 by matching patterns. Alternatively, the respective areas of the regions PP for the finger 2 and for the pen 3 may be determined, and respective value ranges of the corresponding areas may be regarded as the finger recognition pattern data and as the pen recognition pattern data, respectively.

If the same brightness threshold is used to detect the region PP, it is apparent that the sizes of areas where the brightness exceeds the threshold differ between the finger 2 and the pen 3. That is, the region PP of the finger 2 becomes larger than the region PP of the pen 3. Thus, the shape pattern or the range of the area corresponding to the finger 2 is set to be larger than the shape pattern or the range of the area corresponding to the pen 3.

DOWN and UP Input Motion Judgment Process

In the above-mentioned configuration, an input motion judgment process of the information processing device 10 for DOWN input motion and UP input motion will be explained in detail below. In the DOWN input motion, the finger 2 or the pen 3 is moved to make contact with or get close to the input region 1, and in the UP input motion, the finger 2 or the pen 3 that has been in contact with or close to the input region 1 is moved away from the input region 1.

The DOWN and UP input motions correspond to the second input motion of the present invention.

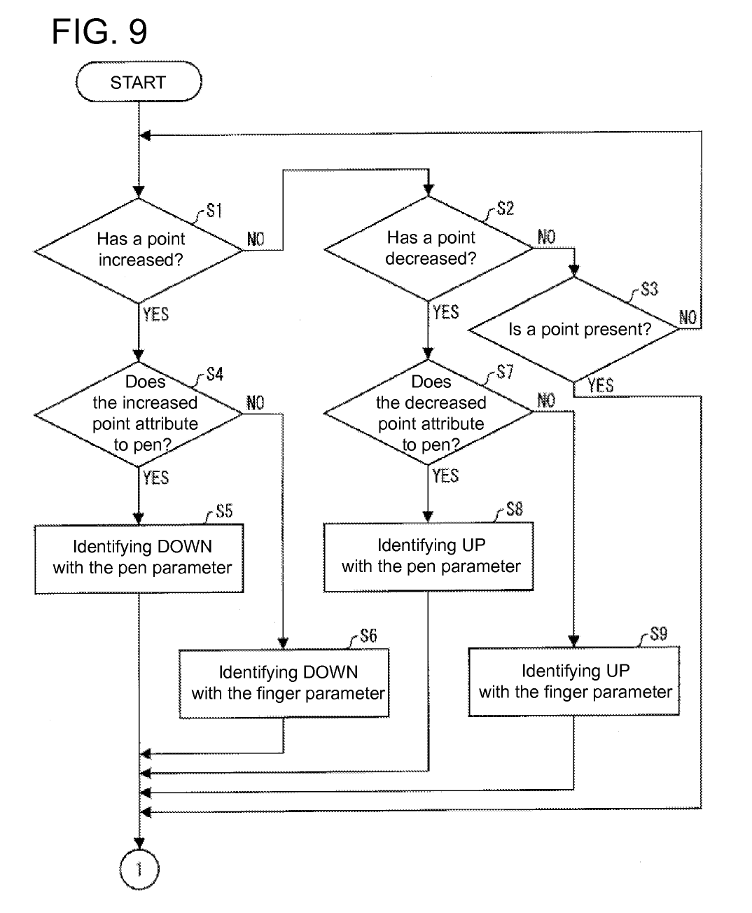

FIG. 9 is a flowchart showing steps of the input motion judgment process. As shown in FIGS. 4 and 9, the gesture determining unit 152 first determines whether or not the number of input points by the finger 2 or the pen 3 has been increased (step 1; hereinafter abbreviated as S1). When the number of points has not been increased in S1, the gesture determining unit 152 determines whether or not the number of points has been decreased (S2). When the number of points has not been decreased in S2, the process moves to S3 where the gesture determining unit 152 determines presence or absence of an input point. When it is determined that there is no input position in S3, the process starts over from S1, and repeats S1 through S3 cyclically until the number of input points is changed.

In order to process the above-mentioned steps S1 to S3, the gesture determining unit 152 stores, in the memory 154, information regarding positions where inputs are presently made by the finger 2 or the pen 3, such as the number of points and positional information including attributes (finger or pen) of the inputs at the respective positions and coordinate data. Therefore, the gesture determining unit 152 can make judgment of S1 and S2 by determining whether to increase or decrease the number of input points having the positional information thereof stored. When no positional information is stored in the memory 154, it can be determined in S3 that the number of input points is zero.

Next, when it is determined that the number of points has been increased in S1, in other words, when the gesture determining unit 152 receives coordinate data and attribute data of an input position from the coordinate generating unit 151; stores the new positional information on the memory 154; and increases the number of input points, the gesture determining unit 152 determines whether or not the attribute of the added input position is a pen in S4. The gesture determining unit 152 can perform the attribute identification process in S4 based on the attribute data provided by the coordinate generating unit 151.

Next, when it is determined that the attribute of the newly added input position is a pen in S4, the gesture determining unit 152 calls up the pen parameter from the storage unit 154E. This pen parameter is the threshold L2 that has been described with reference to FIG. 1, for example. When the movement of the pen 3 is equal to or smaller than the threshold L2, the gesture determining unit 152 can determine that the pen 3 has remained still on the input region 1 without moving, and therefore identifies that this increase of the input position of the pen 3 is DOWN (S5).

In determining DOWN, it is preferable to use a threshold T2 for the time during which the pen 3 is in contact with or close to the input region 1 as the pen parameter, in addition to the threshold L2 for the travel distance of the pen 3. The threshold T2 is set to be twice as long as a scanning period “t” in which the entire region AP shown in FIG. 7 is scanned for detecting an input position, that is, the threshold T2 is set so as to satisfy T2=2 t, for example.

The threshold T2 needs to be provided because when the finger 2 or the pen 3 makes contact with or get closer to the input region 1, a voltage that indicates the correct input position, or the digital value as a result of the image processing by the logic circuit is not output immediately, and this generally creates a need to allow a slight time lag.

This time lag becomes longer as a contact area or a proximity area of an object is larger, which therefore requires a longer time to determine an input position thereof. Further, when the finger 2 is in contact with or close to the input region 1, it is more likely to cause chattering where the input position is detected and lost repeatedly as compared with the pen 2. Therefore, when the threshold T2 of the pen 3 is set to 2 t as described above, it is more preferable to set the threshold T2 of the finger 2 to be greater than 2 t, i.e., 3 t, for example.

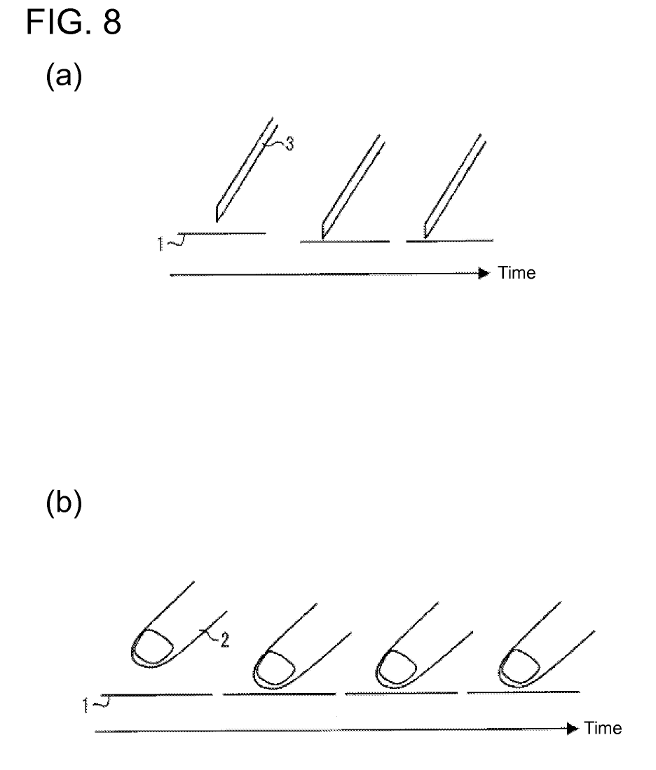

FIG. 8 is an explanatory diagram showing a difference in the threshold T2 between the finger 2 and the pen 3. As shown in FIG. 8(a), in the case of the pen 3, if the pen 3 is in contact with or close to the input region 1 for a period that is equal to or longer than two time units (2 t), the gesture determining unit 152 determines that the DOWN input motion has been performed.

On the other hand, as shown in FIG. 8(b), in the case of the finger 2, when the finger 2 is in contact with or close to the input region 1 for a period that is equal to or longer than three time units (3 t), the gesture determining unit 152 determines that the DOWN input motion has been performed.

As described, the gesture determining unit 152 performs the judgment for DOWN of the pen 3 based on both the threshold L2 and the threshold T2, that is, the gesture determining unit 152 determines the satisfaction of the following condition: the travel distance of the pen 3 is equal to or smaller than the threshold L2, and the duration of the contact or the proximity of the pen 3 is equal to or longer than the threshold T2. This further increases the degree of accuracy in making the judgment of DOWN.

On the other hand, when it is determined that the attribute of the added input position is not a pen in S4, the gesture determining unit 152 calls up the finger parameter from the storage unit 154F. This finger parameter is the threshold L1 that has been described with reference to FIG. 1, for example. When the movement of the finger 2 is equal to or smaller than the threshold L1, it can be determined that the finger 2 has remained still on the input region 1 without moving, and therefore, the gesture determining unit 152 determines that this increase of the input position of the finger 2 is DOWN (S6).

In the case of making judgment for DOWN by the finger 2 as well, the threshold T1 is used in addition to the threshold L1, that is, it is determined whether or not the following conditions are satisfied: the travel distance of the finger 2 is equal to or smaller than the threshold L1, and the duration of the contact or the proximity of the finger 2 is equal to or longer than the threshold T1. This further increases the degree of accuracy in making the judgment for DOWN.

Next, when the gesture determining unit 152 recognizes that the number of input points has been decreased in the above-mentioned S2, that is, when coordinate data of a certain input position is no longer output from the coordinate generating unit 151, and therefore, corresponding positional information is deleted from the memory 154, the process moves to S7.

In S7, the gesture determining unit 152 determines whether or not the attribute of the decreased input position is a pen. If the judgment result of S7 is a pen, the process moves to S8, and if the judgment result of S7 is not a pen, it moves to S9.

In S8, the gesture determining unit 152 calls up the pen parameter from the storage unit 154E in the same manner as S5. If the movement of the pen 3 is equal to or smaller than the threshold L2, it can be determined that the pen 3 has left the input region 1 without moving on the input region 1, and therefore, the decrease of the input position of the pen 3 can be identified as UP.

In S9, the gesture determining unit 152 calls up the finger parameter from the storage unit 154F in the same manner as S6. If the movement of the finger 2 is equal to or smaller than the threshold L1, it can be determined that the finger 2 has left the input region 1 without moving on the input region 1, and therefore, the decrease of the input position of the finger 2 can be identified as UP.

All of the steps S3, S5, S6, S8 and S9 are followed by a subsequent step S10.

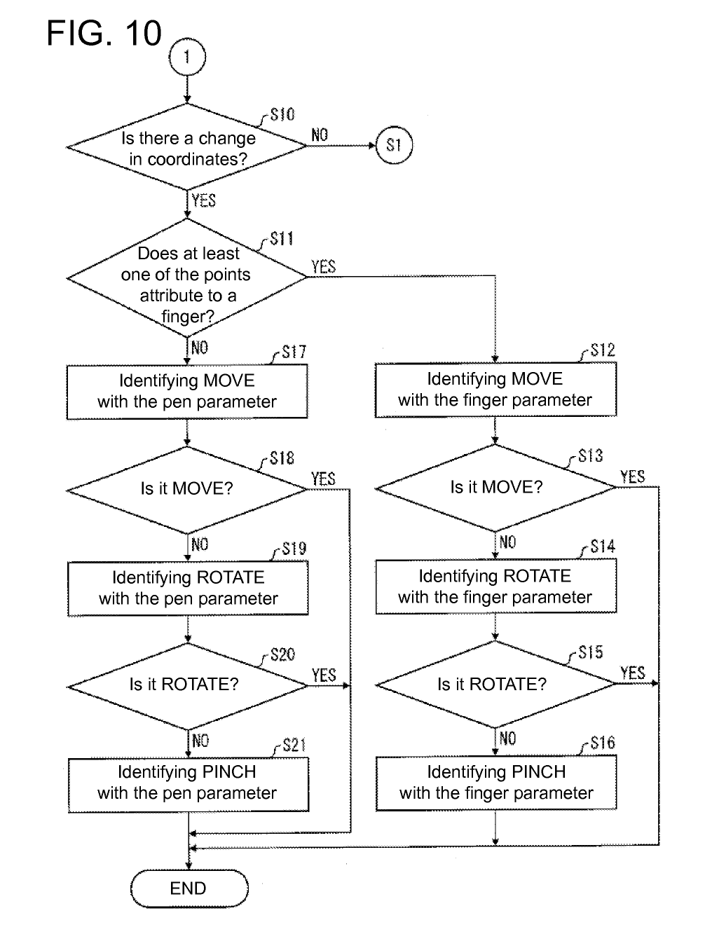

FIG. 10 shows a flowchart illustrating steps of a process in a case where the coordinate data output from the coordinate generating unit 151 has changed, that is, a process for determining the first input motion.

In S10, the gesture determining unit 152 determines presence or absence of a change in coordinate data that is output from the coordinate generating unit 151 for a certain input position. A process for the gesture determining unit 152 to recognize a change in coordinate data is performed in a manner described below, for example.

Out of the coordinate data that has been periodically output from the coordinate generating unit 151 with respect to a certain input position, the memory 154 stores the latest coordinate data and coordinate data one before the latest coordinate data.

The gesture determining unit 152 compares both the current and the previous coordinate data stored in the memory 154 for all of the stored input positions, respectively, and determines whether or not the current coordinate data and the previous coordinate data coincide with each other. The gesture determining unit 152 calculates a difference between the current and the previous coordinate data, for example, and if the difference is within the threshold L1 or L2, it determines that there is no change in coordinate data, and if the difference exceeds the threshold L1 or L2, it determines that there has been a change in coordinate data.

When the gesture determining unit 152 determines that there has been a change in coordinate data with respect to a certain input position in S10, the process moves to S11. If the judgment result in S10 is “No”, the process goes back to S1.

In S11, the gesture determining unit 152 confirms the attributes of all of the input positions by referring to the positional information stored in the memory 154, and determines whether or not the attribute of at least one of the input positions is a finger. When it is determined that at least one of attributes of the input positions is a finger in S11, the process moves to S12.

In S12 and S13, regardless of the attribute of the input position that was determined to have had a change in the coordinate data, the gesture determining unit 152 calls up the finger parameter from the storage unit 154F, and determines whether or not a travel distance of the input position exceeds the threshold L1, in other words, determines whether or not an input motion (MOVE) in which the input position moves linearly on the input region 1 has been performed. That is, even if the attribute of the input position that was determined to have had a change in the coordinate data is to a pen, because at least one of the attributes of the other input positions is a finger, the travel distance of the input position is compared with the finger threshold L1.

As described above, the travel distance of the input position itself can be compared with the threshold L1, but the judgment may also be made by comparing the travel distance of the midpoint M between the input position of the finger 2 and the input position of the pen 3 with the finger threshold L1 as described with reference to FIG. 1.

When the gesture MOVE is performed by two fingers, for example, the midpoint M may be used for determining a direction of the motion. In performing the gesture ROTATE, the midpoint M may be used as a center of the rotation. Similarly, in performing the gesture PINCH, the midpoint M may be used as a center position of the expansion or the shrink.

In this case, a movement of the midpoint M of the two adjacent positions represents a relative movement of the two adjacent positions. This means that not only the positional movement of the respective points, but also the relative movement thereof can be analyzed. This allows for the more sophisticated analysis on input motions.

In any case, when at least one of the attributes of the input positions is a finger, the movement of the respective input positions or the movement of the midpoint of the adjacent input positions is determined in accordance with the finger assessment criterion. Therefore, even if the finger 2 moves to some extent, if the movement is smaller than the threshold L1, the finger 2 is deemed to have remained still. This prevents a problem of detecting an input motion not intended by an operator and therefore performing erroneous information processing.

When the change in coordinate data was identified as MOVE in S13 above, the determining process for the first input motion is completed. On the other hand, when the coordinate data change was not identified as MOVE, the process moves to S14 and S15.

In S14 and S15, it is determined whether or not the travel distance of the input position exceeds the threshold L1, and whether or not the movement is the input motion (ROTATE) in which the input positions move in a curve on the input region 1. When the change in coordinate data is identified as ROTATE in S15 above, the determining process for the first input motion is completed. On the other hand, when the change in coordinate data is not identified as ROTATE, the process moves to S16.

In S16, it is determined whether or not the travel distance of the input position exceeds the threshold L1, and the movement is the input motion (PINCH) in which the distance between the two adjacent input positions is expanded or shrunk on the input region 1. With this step of determining PINCH, the entire first input motion determining process is completed.

On the other hand, when it is determined that none of the attributes of the input positions is a finger in S11 above, the process moves to S17. The judgment for MOVE, ROTATE, and PINCH in S17 through S21 is performed based on the threshold L2 for a pen, which is the input tool assessment criterion. The only difference between the steps S17 through S21 and the steps S12 through S16 is the assessment criterion to be used, therefore, the overlapping explanations will be omitted.

The present invention is not limited to the above-mentioned embodiments, and various modifications can be made without departing from the scope specified by the claims. Other embodiments obtained by appropriately combining the techniques that have been respectively described in the above-mentioned embodiments are included in the technical scope of the present invention.

In the information processing device according to the present invention, when a second input motion of moving the input tool or a finger so as to make contact with or get close to the input region or moving the input tool or a finger away from the input region is performed, the analysis unit calls up the input tool assessment criterion for the input tool and the finger assessment criterion for the finger, respectively, from the storage unit, and analyzes the second input motion.

In the configuration above, the second input motion is an input motion that is generally referred to as pointing, which is performed to specify a certain point in the input region. In order to distinguish the second input motion from a first input motion of moving a finger or an input tool along a surface of the input region, it is preferable to use different assessment criteria for different input instruments depending on scales of coordinate changes caused by the respective input instruments.

That is, when the finger assessment criterion provided for recognizing a larger change in coordinates is used for an input tool such as a pen that causes a smaller change in coordinates, even though the operator thinks that she/he wrote a small letter by using the input tool, the input tool is determined to have remained still, and therefore, the input is erroneously recognized as a pointing operation.

In contrast, when the input tool assessment criterion provided for recognizing a smaller change in coordinates is used for a finger that causes a larger change in coordinates, even though an actual operation performed by a finger was a pointing operation, it is erroneously recognized that the operator has moved the finger.

Therefore, by using the finger assessment criterion for the second input motion by a finger, and by using the input tool assessment criterion for the second input motion by the input tool, the second input motion can be accurately analyzed.

In the information processing device according to the present invention, a threshold for a distance that the input tool travels along the surface of the input region is used as the input tool assessment criterion, and a threshold for a distance that the finger travels along the surface of the input region is used as the finger assessment criterion.

This makes it possible to perform an assessment of the first input motion by the input tool and the first input motion by a finger with specifically different resolutions. By setting the threshold for the travel distance of the input tool to be smaller than the threshold for the travel distance of a finger, for example, the first input motion by the input tool can be assessed with a higher resolution as compared with the first input motion by a finger.

In the information processing device according to the present invention, with respect to the second input motion of moving the input tool or a finger so as to make contact with or get close to the input region, the input tool assessment criterion further includes a threshold for a time during which the input tool is in contact with or close to the input region, and the finger assessment criterion further includes a threshold for a time during which the finger is in contact with or close to the input region.

In the above-mentioned configuration, when a finger or an input tool makes contact with or gets close to the input region, data indicative of a correct input position is not output immediately, and therefore, generally, it is necessary to allow a small time lag.

This time lag becomes longer for an object that has the larger contact area or proximity area, which requires a longer time for determining an input position thereof. Further, when a finger is in contact with or close to the input region, it is more likely to cause chattering where the input position is detected and lost repeatedly as compared with the input tool.

Therefore, when the time during which a finger is in contact with or close to the input region exceeds the threshold time for a finger, for example, it can be determined that the second input motion of moving a finger so as to make contact with or get close to the input region did take place.

With respect to an input tool that has a shorter time lag, when the time during which the input tool is in contact with or close to the input region exceeds the threshold time for the input tool, it can be determined that the second input motion of moving the input tool so as to make contact with or get close to the input region did take place.

By combining the time thresholds and the travel distance thresholds, an accuracy of analysis in determining execution of the second input motion can further be improved.

In the information processing device according to the present invention, when the input identifying unit determines that the input tool or fingers are in contact with or close to the input region in at least two locations and when the analysis unit analyzes the above-mentioned first input motion, the analysis unit uses a distance that a position of a midpoint of two adjacent positions travels along the surface of the input region as the target of comparison with the input tool assessment criterion or the finger assessment criterion, or uses such a distance as an additional target of comparison.

In this case, a movement of the position of the midpoint of the two adjacent positions represents a relative movement of the two adjacent positions. Therefore, by performing an analysis on the relative movement, in addition to the analysis on the positional movement of the positions of the respective points, more sophisticated analysis of input motions can also be achieved.

When two adjacent points move in the opposite directions to each other, respectively, for example, if the respective points move at different speeds, the position of the midpoint is moved in a certain direction. In this case, the two points may be determined to have moved in the above-mentioned certain direction by looking only at the movement of the position of the midpoint, or the information processing may also be performed in accordance with the movements of the three points, which are the above-mentioned two points and the midpoint.

In terms of combining a configuration described in a particular claim and a configuration described in another claim, the combination is not limited to the one between the configuration described in the particular claim and a configuration described in a claim that is referenced in the particular claim. As long as the objects of the present invention can be achieved, it is possible to combine a configuration described in a particular claim with a configuration described in another claim that is not referenced in the particular claim.

### INDUSTRIAL APPLICABILITY

The present invention can be suitably used for any information processing devices that allow an operator to enter commands for information processing into a display screen by using his finger or an input tool such as a pen.

### DESCRIPTION OF REFERENCE CHARACTERS

1 input region

2 finger

3 pen

10 information processing device

151 coordinate generating unit (input identifying unit)

152 gesture determining unit (analysis unit)

154 memory (storage unit)

154E storage unit

154F storage unit

L1 threshold (finger assessment criterion)

L2 threshold (input tool assessment criterion)

1. An information processing device that can simultaneously receive an input motion of a finger and an input motion of an input tool thinner than the finger in a single input region in a display screen, the information processing device performing information processing in accordance with said input motions, the information processing device, comprising:
an input identifying unit that determines whether the input tool or the finger is in contact with or close to the input region;
a storage unit that therein stores an input tool assessment criterion and a finger assessment criterion, the input tool assessment criterion being provided for assessing the input motion by the input tool, the finger assessment criterion being provided for assessing the input motion by a finger and having a lower resolution to assess input motions than that of the input tool assessment criterion; and
an analysis unit, wherein, when the input identifying unit detects that a finger is in contact with or close to the input region in at least one location and when a first input motion of moving the input tool or a finger along a surface of the input region is performed, the analysis unit calls up the finger assessment criterion from the storage unit, and analyzes the first input motion of the input tool or a finger based on the finger assessment criterion.

2. The information processing device according to claim 1, wherein, when a second input motion of moving the input tool or a finger so as to make contact with or get close to the input region or moving the input tool or a finger away from the input region is performed, the analysis unit calls up the input tool assessment criterion for the input tool and the finger assessment criterion for the finger, respectively, from the storage unit, and analyzes the second input motion.

3. The information processing device according to claim 2, wherein the input tool assessment criterion is a threshold for a distance that the input tool travels along the surface of the input region, and the finger assessment criterion is a threshold for a distance that the finger travels along the surface of the input region.

4. The information processing device according to claim 3, wherein, for the second input motion of moving the input tool or a finger so as to make contact with or get close to the input region, the input tool assessment criterion further includes a threshold for a time during which the input tool is in contact with or close to the input region, and the finger assessment criterion further includes a threshold for a time during which the finger is in contact with or close to the input region.

5. The information processing device according to claim 3, wherein, when the input identifying unit determines the input tool or finger are in contact with or close to the input region in at least two locations and when the analysis unit analyzes the first input motion, the analysis unit uses a distance that a midpoint of two adjacent points travels along the surface of the input region as the target of comparison with the input tool assessment criterion or the finger assessment criterion, or uses said distance as an additional target of comparison.

6. An input motion analysis method that is performed by an information processing device, the information processing device being capable of simultaneously receiving an input motion of a finger and an input motion of an input tool thinner than the finger in a single input region in a display screen, the information processing device performing information processing in accordance with said input motions, the input motion analysis method comprising:
when an operator of the information processing device performs a first input motion by moving the input tool or the finger along a surface of the input region while keeping at least the finger in contact with or close to the input region, analyzing the first input motion of the input tool or the finger based on a finger assessment criterion, instead of an input tool assessment criterion, the input tool assessment criterion being provided for assessing the input motion of the input tool, the finger assessment criterion being provided for assessing the input motion by a finger and having a lower resolution to assess input motions than that of the input tool assessment criterion.
